(19) United States
(12) Patent Application Publication
(10) Pub. No.: US 2009/0027334 A1
(43) Pub. Date: Jan. 29, 2009

(54) METHOD FOR CONTROLLING A GRAPHICAL USER INTERFACE FOR TOUCHSCREEN-ENABLED COMPUTER SYSTEMS

(75) Inventors: Eugene Foulk, Ann Arbor, MI (US); Ronald Hay, Ann Arbor, MI (US); Katherine Scott, Ann Arbor, MI (US); Merrill D. Squiers, Chelsea, MI (US); Joseph Tesar, Ann Arbor, MI (US); Charles J. Cohen, Ann Arbor, MI (US); Charles J. Jacobus, Ann Arbor, MI (US)

Correspondence Address: GIFFORD, KRASS, SPRINKLE,ANDERSON & CITKOWSKI, P.C, PO BOX 7021, TROY, MI, 48007-7021, US

(73) Assignee: Cybernet Systems Corporation, Ann Arbor, MI (US)

(21) Appl. No.: 12/131,375

(22) Filed: Jun. 2, 2008

Related U.S. Application Data
(60) Provisional application No. 60/941,485, filed on Jun. 1, 2007.

(51) Int. Cl. G06F 3/033; G06F 3/041

(52) U.S. Cl. 345/157; 345/173

(57) ABSTRACT

A method for controlling a graphical user interface (GUI) for a touchscreen-enabled computer systems provides a variety of software methods (tools) provide for high-fidelity control of the user interface. The TrackScreen tool provides finger-friendly mouse functions such as scrolling, dragging and clicking. The Magnifier application continuously captures the current screen image, and displays a magnified subset of it. Selecting within this magnified area with a pointing device (mouse, touchscreen, digitizer, etc) causes the application to simulate the action on the portion of the screen corresponding to the point in the magnified image that was selected. A KeyBoard application, a keyboard is rendered on screen, with sufficient size that the individual keys are easily selectable with an unaided finger. The Common Tasks Tool or CTT) allows common keyboard shortcuts, mouse events, and other user interface events to be specified in a configuration file and represented on screen as a large, easy-to-click button. The Touchscreen Task Switcher is invoked using any interface (software or hardware) element, and visually takes up the entire screen. The Touchscreen Snapshot utility ties in with an external camera with a physical button on it. The Window Template Manager (WTM), is used to specify, and then instantiate, the position and sizes of multiple windows for use with a touchscreen display. The Touch Portal is a full-screen application with a set of customizable buttons representing applications and other tools.

### REFERENCE TO RELATED APPLICATION

This application claims priority from U.S. Patent Application Ser. No. 60/941,485, filed Jun. 1, 2007, the entire content of which is incorporated herein by reference.

### FIELD OF THE INVENTION

This invention relates generally to tablet-like personal computers, and the like, and more particularly to portable electronic devices with improved user interfaces.

### BACKGROUND OF THE INVENTION

In the late 1960s, Alan Kay of Xerox PARC proposed a notebook using pen input called Dynabook. In 1989, the first commercially available tablet-type computer, the GRiDPad from GRiD Systems, was released. Its operating system was based on MS-DOS. A notebook or slate-shaped mobile computer was first introduced by Pen Computing in the early 90s with its PenGo Tablet Computer popularized by Microsoft. Its touchscreen or graphics tablet/screen hybrid technology allows the user to operate the computer with a stylus or digital pen, or a fingertip, instead of a keyboard or mouse.

Since these initial introductions, different types of these mobile devices have evolved. Slates, which resemble writing slates, are tablet PCs without a dedicated keyboard. Keyboards can usually be attached via a wireless or USB connection. These tablet PCs typically incorporate small (8.4-14.1 inches/21-36 cm) LCD screens and have been popular for quite some time in vertical markets such as health care, education, and field work. Slate models are often designed with a focus on pure mobility, that is, the less to carry, the better.

Thin-client slates incorporate a touchscreen and an integrated wireless connection device. These units by design have limited processing power which is chiefly involved with Input/Output data processing such as video display, network communications, audio encoding/decoding, and input capture (touchscreen input, bar code reading, magnetic stripe reading (credit card swipe). The unit transmits data via a secured wireless connection to a remote server for processing. Thin-client slates have the design advantages of a very lightweight form factor, more secure data (no data storage on the slate computer), long battery life (no processor to power). The Panasonic Toughbook 08 is representative of the application of thin-client computing to tablet PCs.

Convertible notebooks have a base body with an attached keyboard. They more closely resemble modern notebooks/laptops, and are usually heavier and larger than slates. Typically, the base of a convertible attaches to the display at a single joint called a swivel hinge or rotating hinge. The joint allows the screen to rotate around 180° and fold down on top of the keyboard to provide a flat writing surface.

The capabilities and features of all these devices have risen dramatically over the years. According to U.S. Pat. No. 6,278,443, a computer controlled display system with a user interactive touch screen is provided with an on-screen mouse to which user input may be applied by rolling of the touch finger to thereby move displayed information: the pointer or scrolled information on the screen. Means are provided which are activated by the touching of the screen at any random position selected by the user for enabling the detection of any rolling of said placed fingertip in an orthogonal direction. Also provided are means responsive to the detection of said rolling of said placed fingertip for moving said displayed data in an orthogonal direction corresponding to the direction of said rolling. The data moved may be the cursor or pointer or, when scrolling, the whole screen of data may be moved.

U.S. Pat. No. 7,054,965 describes the use of a touchscreen on a device to act as a trackpad on another device. The movement of a user's finger may control the position of a cursor displayed on a screen of the other component so that the core component exhibits the behavior of a trackpad when operating in the second mode.

U.S. Pat. No. 6,029,214 describes a computer system including an input pointer, a tablet having a two-dimensional tablet surface, and a data processor coupled to the tablet and operative to receive coordinate data from the tablet. The coordinate data is preferably in absolute-mode, and the data processor processes the coordinate data such that coordinate data influenced by a first segment of the tablet surface is processed in a relative-mode fashion, and coordinate data influenced by a second segment of the tablet surface is processed in an absolute-mode fashion. In consequence, the tablet is segmented for simultaneous relative-mode and absolute-mode operation. The segments can take on a number of configurations depending upon the configuration of the computer screen, the application program running, and user preferences.

U.S. Pat. No. 6,211,856 discloses a graphical user interface touch screen having an entire collection of icons displayed at a scale in which the individual function of each icon is recognizable, but too small to easily access features of the function, and wherein upon touching the screen area accommodating an area of the icon, the screen provides a zoomed in version of that area so that the user can select a desired feature.

A customizable touchscreen keyboard, and method, system, and computer program product for customizing the touchscreen keyboard is discussed in U.S. Pat. No. 6,724,370. In one embodiment, a data processing system receives customization characteristics from a user through the touchscreen interface. The data processing system then creates a customized touchscreen keyboard layout based on the customization characteristics and presents the customized touchscreen keyboard layout to a user. For example, the user may customize the keyboard such that the letters are presented in a U-shape with the letters arranged in alphabetical order, thus aiding a user in finding a desired letter. The user may later recustomize the keyboard if desired. Furthermore, the data processing system may reconfigure the keyboard based on past usage by the user.

A method and apparatus for managing the display of multiple windows in a computer user interface in an efficient manner is the subject of U.S. Pat. No. 5,487,143. Two separate window areas are allocated in a display area. A first area is an overlapped window area where windows may overlap each other. A second area is a tiled window area where windows may not overlap each other. User interface controls are provided to allow the user to designate a displayed window as tiled or overlapped and the designated window is moved from area to area, accordingly. Windows in either area may be resized and repositioned, although with some restrictions in the tiled area. The computer system automatically adjusts window and area sizes within predefined limits.

U.S. Pat. No. 5,119,079 discloses touch screen technology and the ability to male a pull down menu. The system includes a touch sensitive user interface of the type having a display screen for displaying an image; control logic responsive to the touch sensitive user interface for determining the contact position of a probe, such as a finger, thereon; a display menu of operating features, represented by a plurality of images on the display screen, so that a user may male touch selections on the images corresponding to operating features desired; a system controller for identifying a contact zone of a predetermined size with respect to the display screen, the control logic actuating the feature within the system represented by a displayed image in response to user touch within a corresponding contact zone, the system controller enlarging the contact zone of a selected feature upon selection thereof to a size accommodating a probe tip, without overlapping on adjacent areas and upon completion of option selection, returning the expanded contact areas to said predetermined size.

U.S. Pat. No. 5,559,301 describes a touch screen interface for a sound processing system, such as music synthesizers, which has a display panel and a touch sensitive panel overlying the display panel, includes an icon which represents an adjustable parameter used by the processing system. The processing resources supply a variable adjustment display to the display panel in response to a touch on the position of the icon, using pop-up slider or pop-up knob motif. The variable adjustment display overlies the interface display and has a size on the touch sensitive panel larger than the size of the icon to facilitate manipulation of the variable using a finger over a significant range of values. The variable adjustment display pops up when touched to obscure a portion of the graphical display used for the interface. When the variable is adjusted using the touch sequence, the variable adjustment display is removed, and the interface display is left unobscured. This allows the user to manipulate a particular variable while maintaining the window which shows the values of related variables on the screen. By maintaining the current window on the screen, the user is less likely to get lost in a hierarchy of windows used for setting variables.

A computer-implemented user interface having a semi-transparent scroll bar tool for increased screen usage is disclosed in U.S. Pat. No. 6,057,840. The scroll bars are semi-transparent in that they allow the visualization of text and/or other graphical information that coincides in screen location with the scroll bars (e.g., “behind information”). Each scroll bar tool includes a semi-transparent graphical image with which a user can interact thereby effecting the horizontal or vertical scrolling of text and/or other graphical information associated with an open work file or “document.” In one embodiment, the size of the graphical image depends on the relative portion of information displayed on the display screen to the total information within the open document in a given direction (e.g., horizontal or vertical).

### SUMMARY OF THE INVENTION

This invention resides in a method for controlling a graphical user interface (GUI) for touchscreen-enabled computer systems. A variety of software methods (tools) provide for high-fidelity control of the user interface.

The TrackScreen tool provides finger-friendly mouse functions such as scrolling, dragging and clicking. A scaling ratio may be applied to the input to amplify or attenuate the magnitude of the input. This ratio can vary as appropriate depending on the screen size of the device, application, and user preference. Indeed, smoothing and scaling can be applied to any step (including multiple steps) in the process, from on the raw hardware input through the final cursor position values. The computed cursor position is inserted back into the operating system, providing pointing device input to the rest of the system. Optionally, certain regions of the screen can be designated to be excluded from the above processing. In such regions, the original pointing device input would be directly applied to retain absolute mode input in that region. These regions can both be utilized by the TrackScreen application itself to provide special functionality, such as simulating mouse clicks or scroll wheel activity, or by external application which are specifically designed for absolute mode input and interface with the TrackScreen application.

The Magnifier application continuously captures the current screen image, and displays a magnified subset of it. Selecting within this magnified area with a pointing device (mouse, touchscreen, digitizer, etc) causes the application to simulate the action on the portion of the screen corresponding to the point in the magnified image that was selected.

In accordance with a KeyBoard application, a keyboard is rendered on screen, with sufficient size that the individual keys are easily selectable with an unaided finger. In the preferred embodiment, the occlusion of the keyboard produces is mitigated by making the keyboard semitransparent.

The Common Tasks Tool or CTT) allows common keyboard shortcuts, mouse events, and other user interface events to be specified in a configuration file and represented on screen as a large, easy-to-click button. The buttons are automatically arranged in horizontal rows, and presented on screen without a backdrop. Each button has a graphic or text representing the action they correspond to. When the user wishes to perform a common task, the CTT is invoked (using a hardware or software button or other interface mechanism) and appears on screen. The desired button (“Paste” or “Control V” for instance) is pushed and the user interface event is pushed into the appropriate buffer for the event. As such, keyboard events are pushed onto the keyboard buffer using standard Operating System hooks. The same holds true with mouse events. Once the button is pushed, the Common Task Tool closes.

The Touchscreen Task Switcher is invoked using any interface (software or hardware) element, and visually takes up the entire screen. It is composed of a close button, and a number of buttons corresponding to the running applications. Each button typically includes a graphic or text communicating the application they represent. The user then either selects one of the application buttons, or dismisses the Touchscreen Task Switcher using the close button. If an application button is pushed, the Touchscreen Task Switcher is dismissed, and the corresponding application is brought to the foreground.

The Touchscreen Snapshot utility ties in with an external camera with a physical button on it. When the button is pressed, the Snapshot utility is launched as a window that takes up a majority of the screen. In this window is the video feed from the external camera. On the screen are two, large buttons, one for “capture,” and another for “done.”

The Window Template Manager (WTM), is used to specify, and then instantiate, the position and sizes of multiple windows for use with a touchscreen display. Interacting with a windows-based operating system is difficult when using a touchscreen, as the operator's finger (or other touching device) is much larger than a stylus, and obscures that which is being interacted with. Window sizing and placement requires interacting with very small elements (window edge, or the window corner) making this problem even worse. The Window Template Manager is used to reduce the complexity and frustration of these tasks.

The Touch Portal is a full-screen application with a set of customizable buttons representing applications and other tools. Each button typically includes a graphic or text communicating the application they represent. The buttons can be split into two sections, one for applications, and the other for touchscreen tools. There are two other special buttons, one that dismisses the Portal, and one that sends the Portal window to the background. A configuration file associates buttons with the application or tool they represent, as well as the icon to use for that button. In use, the operator simply brings up the Portal using an interface element (software or hardware) and then either dismisses the Portal, or pushes on the button representing the application or tool they wish to launch. Once the button is pushed, the Portal then goes to the background.

### BRIEF DESCRIPTION OF THE DRAWINGS

FIG. 1 shows a tablet type computer displaying a Track Screen Tool according to the invention;

FIG. 2 shows a tablet type computer displaying a Magnifier Tool according to the invention;

FIG. 3 shows a tablet type computer displaying a Keyboard according to the invention;

FIG. 4 shows a tablet type computer displaying a Common Tasks Tool according to the invention;

FIG. 5 shows a tablet type computer displaying a Task Switcher Tool according to the invention;

FIG. 6 shows a tablet type computer displaying a Camera Snapshot Tool according to the invention; and

FIG. 7 shows a tablet type computer displaying a Template Manager according to the invention.

### DETAILED DESCRIPTION OF THE INVENTION

This invention resides in a method for controlling a graphical user interface (GUI) for touchscreen-enabled computer systems. A variety of software methods (tools) provide for high-fidelity control of the user interface. Each of the tools, which can be used independently or in combinations), will be described in turn, as follows.

### Track Screen

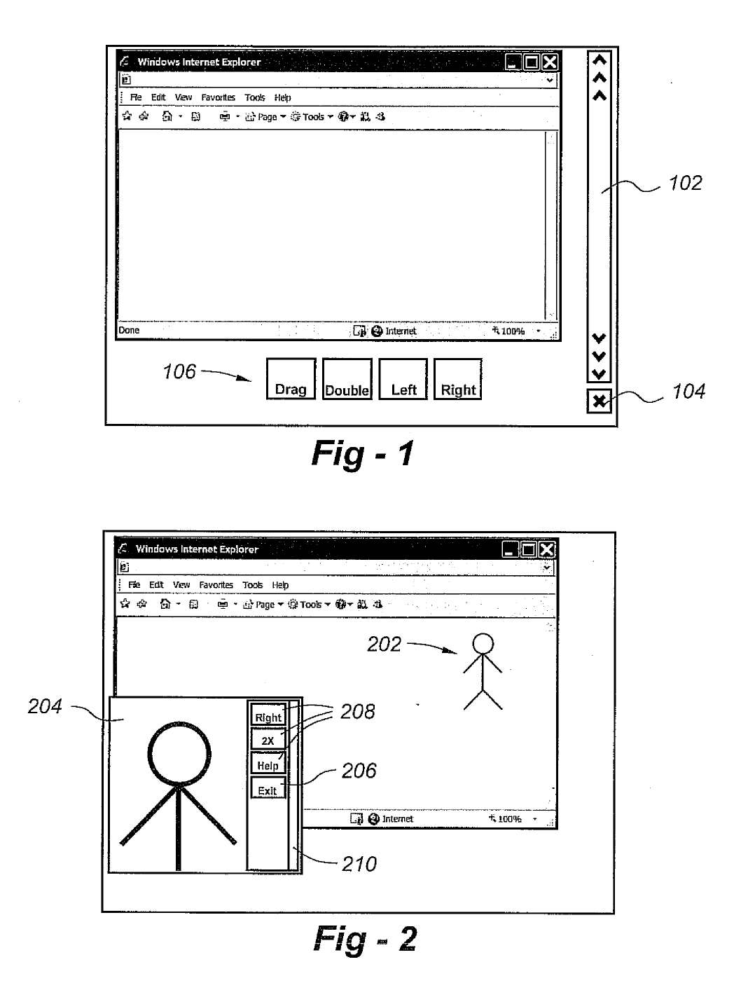

The TrackScreen tool, depicted in FIG. 1, provides finger-friendly mouse functions such as scrolling, dragging and clicking. When invoked, a mouse click selection area appears on the display, shown at the bottom of FIG. 1. A scroll bar overlay appears at the right, as well as a touch area to close the tool.

The TrackScreen tool intercepts input from an absolute pointing device (such as touchscreen or digitizer) via operating system hooks or other methods. This input is consumed, preventing the rest of the system, including other applications, from receiving it. The input is then compared against a previously acquired position to determine a position delta; the input is also stored for comparison against future input. The position delta is then applied to the current cursor position, such that the cursor moves in vector relative to the original input. The position delta is then as needed, depending on the resolution and responsiveness of the hardware device, using any suitable smoothing function.

A scaling ratio may be applied to the input to amplify or attenuate the magnitude of the input. This ratio can vary as appropriate depending on the screen size of the device, application, and user preference. Indeed, smoothing and scaling can be applied to any step (including multiple steps) in the process, from on the raw hardware input through the final cursor position values. The computed cursor position is inserted back into the operating system, providing pointing device input to the rest of the system.

Optionally, certain regions of the screen can be designated to be excluded from the above processing. In such regions, the original pointing device input would be directly applied to retain absolute mode input in that region. These regions can both be utilized by the TrackScreen application itself to provide special functionality, such as simulating mouse clicks or scroll wheel activity, or by external application which are specifically designed for absolute mode input and interface with the TrackScreen application.

### Magnifier

The Magnifier application, shown in FIG. 2, continuously captures the current screen image, and displays a magnified subset of it. Selecting within this magnified area with a pointing device (mouse, touchscreen, digitizer, etc) causes the application to simulate the action on the portion of the screen corresponding to the point in the magnified image that was selected. This is performed by taking the coordinate within the magnified image and trivially transforming it by the magnifier image location, the location of the magnified image, and the magnification ratio. The computed cursor position is then inserted into the operating system, providing pointing device input to the rest of the system. Buttons are provided to select the various mouse actions (right click, double click, etc) that can be performed on the location selected within the magnified image.

### Keyboard

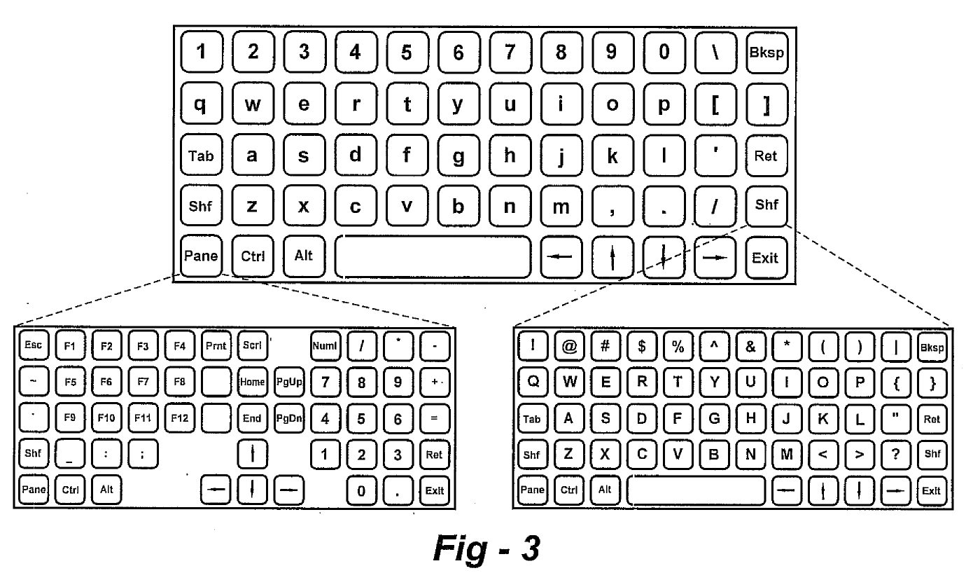

A keyboard is rendered on screen, with sufficient size that the individual keys are easily selectable with an unaided finger, as shown in FIG. 3. In the preferred embodiment, the occlusion of the keyboard produces is mitigated by malting the keyboard semi-transparent. If the large size of the keys precludes rendering all common keys to the screen simultaneously, a button is provided that switches between different portions of the keyboard when selected. Selected keys are inserted into the operating system, providing keyboard input to the rest of the system.

### Tool for Accelerating Common Tasks Using a Touchscreen

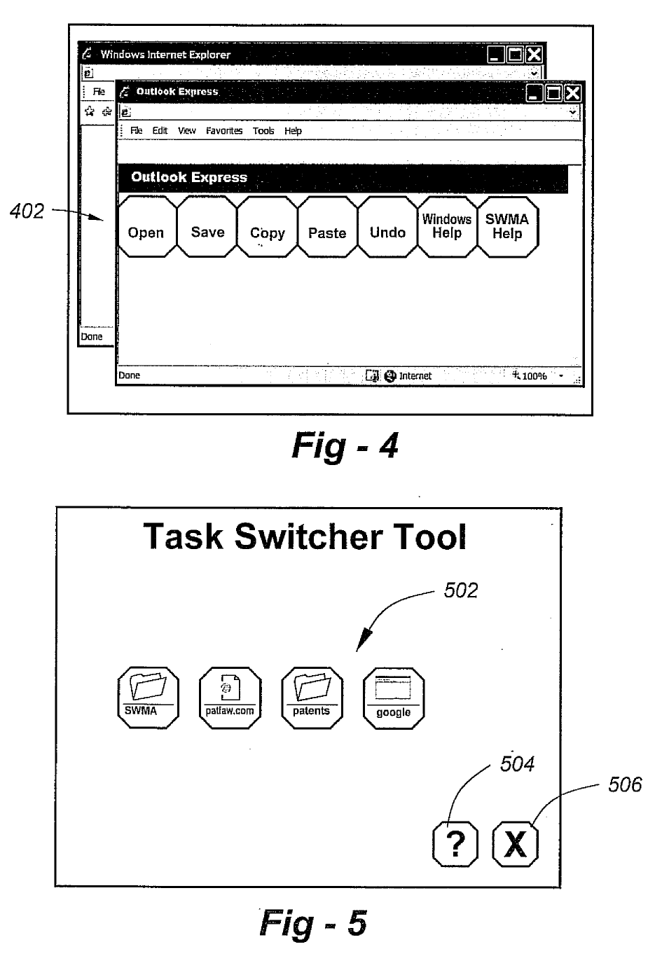

This tool (Common Tasks Tool or CTT) allows common keyboard shortcuts, mouse events, and other user interface events to be specified in a configuration file and represented on screen as a large, easy-to-click button. The buttons are automatically arranged in horizontal rows, and presented on screen without a backdrop, as shown in FIG. 4. Each button has a graphic or text representing the action they correspond to. The tool does not take focus from the currently running application.

When the user wishes to perform a common task, the CTT is invoked (using a hardware or software button or other interface mechanism) and appears on screen. The desired button (“Paste” or “Control V” for instance) is pushed and the user interface event is pushed into the appropriate buffer for the event. As such, keyboard events are pushed onto the keyboard buffer using standard Operating System hooks. The same holds true with mouse events. Once the button is pushed, the Common Task Tool closes. If the user does not desire to use any of the buttons, tapping on the screen anywhere but one of the buttons dismisses the CTT. The buttons should be sized such that they are a bit bigger than a fingertip—nominally 1″×1″. However, the button should be bigger if the user is likely to be wearing gloves.

### Tool for Switching Between Running Applications Using a Touchscreen

A common need when using a windows-based operating system is the ability to switch between running applications. While the standard task switchers work well for a keyboard-mouse environment, most touchscreen systems do not have those interface devices. The result is that the elements of standard tasks switchers are too small to be easily interacted with using a touchscreen. The Touchscreen Task Switcher is invoked using any interface (software or hardware) element, and visually takes up the entire screen, as shown in FIG. 5. It is composed of a close button, and a number of buttons corresponding to the running applications. Each button typically includes a graphic or text communicating the application they represent. The buttons are preferably sized such that they are a bit bigger than a fingertip—nominally 1″×1″. However, the button could be bigger if the user is likely to be wearing gloves. The user then either selects one of the application buttons, or dismisses the Touchscreen Task Switcher using the close button. If an application button is pushed, the Touchscreen Task Switcher is dismissed, and the corresponding application is brought to the foreground.

Tool for Capturing a Snapshot from an External Camera and Pasting the Image into Other Applications

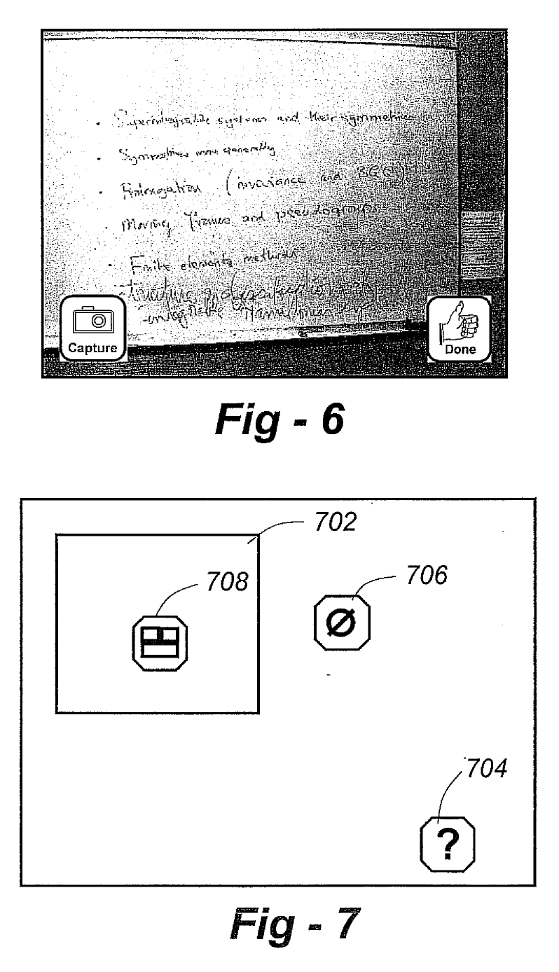

The Touchscreen Snapshot utility ties in with an external camera with a physical button on it. When the button is pressed, the Snapshot utility is launched as a window that takes up a majority of the screen. In this window is the video feed from the external camera. On the screen are two, large buttons, one for “capture,” and another for “done,” as illustrated in FIG. 6. The buttons are preferably sized such that they are a bit bigger than a fingertip—nominally 1″×1″. However, the button should be bigger if the user is likely to be wearing gloves. One button will dismiss the Snapshot utility, the other will take a snapshot of the video stream and put it in the operating system clipboard.

Once in the clipboard, the snapshot can then be pasted into any other application that supports such an operation. However, the user can also use the hardware button on the external camera to perform the operations. After the first time the button is pushed and the Snapshot utility comes up, the button can be pushed again. If the button is pushed while the Snapshot utility is in the foreground, a snapshot will be taken (capture an image from the video stream and place it into the clipboard). If the button is pushed while the Snapshot utility is not in the foreground, the foreground application is sent a “paste” (Control-V) keyboard message. If the foreground application supports pasting a picture in such a manner, then the snapshot in the clipboard will be pasted into the application.

The hardware button functionality is implemented by causing the hardware button to launch the Snapshot executable. The Snapshot executable then iterates through the list of running applications—if another instance of the Snapshot executable is running, and it is the foreground window, a “Snapshot Message” is sent to that executable, and the second executable exits without bringing up its window. If the other executable is not in the foreground, the new executable sends a paste message to the current foreground window. If no other Snapshot executable is running, then the Snapshot utility starts up as normal.

### Tool for Quickly Placing and Sizing Windows With a Touchscreen

This tool, referred to as the Window Template Manager (WTM), is used to specify, and then instantiate, the position and sizes of multiple windows for use with a touchscreen display. Interacting with a windows-based operating system is difficult when using a touchscreen, as the operator's finger (or other touching device) is much larger than a stylus, and obscures that which is being interacted with. Window sizing and placement requires interacting with very small elements (window edge, or the window corner) making this problem even worse. The Window Template Manager, shown in FIG. 7, is used to reduce the complexity and frustration of these tasks.

A “Template” is a named collection of rectangular regions on the screen that abstractly represent window sizes and positions. When the WTM is first started, it runs full screen, although the application is around 60% translucent to allow the user to see the windows open on the desktop underneath it. A list shows existing, named Templates. There is a set of buttons that the user interacts with initially. The buttons should be sized such that they are a bit bigger than a fingertip—nominally 1″×1″. However, the button should be bigger if the user is likely to be wearing gloves. The buttons have graphics and text on them indicating what they will do when pushed. The initial buttons are:
Create New Template—Allows the user to create a new, named template. This switches the interface to the “New Template” mode described below.
Delete Selected Template—if a template is selected in the list, this button brings up a confirmation dialog, which if “yes” is selected, causes the selected template to be deleted.
Use Selected Template—When a template is selected in the list and this button is pushed, the interface switches to the “Use Template” mode described below.
View/Edit Layouts—Switches the interface to Layout mode. A layout is a template plus a set of associated executables. This mode is described below.
Up/Down—A button with an up arrow and a button with a down arrow. These buttons select the previous or next element in the list, based on the current selection. While the list can be clicked on directly, these buttons are easier to use with a touchscreen.
Help—Brings up a quick help screen describing the use of the software.
Close—Dismisses the WTM.

### “New Template” Mode:

When the New Template button is pushed, the interface changes. The translucent backdrop remains, but all buttons except help are removed except the help button. Two new buttons are added:
Save Template—Saves the new template by prompting for a name and then inserting that name and associated template into the main list. On successful save, the interface switching back to the original.
Cancel—Returns the interface to the initial one without saving a new template.

In this mode, the user can drag out regions of the screen, visually represented as a black rectangle. Each new rectangle represents an abstract location and size for a window. After specifying 1 or more regions, the template may be saved.

### “Use Template” Mode:

The list switches to a list of running applications. The up/down and help buttons remain, all others are removed from the interface. The user can select applications in the list, and then tap on one of the regions in the template. That window will be placed and sized according to the region. The user can see this placement and resizing since the backdrop is translucent. It will also cause the placed window to come to the foreground (although still behind WTM). The user can place (or replace) as many applications as desired in this manner. Additionally, there are two new buttons:
Done—When done placing applications in regions in the template, the user can click the Done button, which returns the interface to its original, launched mode.
Save Layout—A layout is a template and a set of associated executables. After the user has placed applications by specifying the application and then the region, this associated can be saved into a named Layout using the Save Layout button. The button brings up a naming dialog with Ok/Cancel options. “Ok” saves the layout to the specified name, “Cancel” closes the naming dialog without saving.

### “Layout” Mode:

In Layout Mode, the list of template is replaced by a list of named Layouts. A Layout is a template with associated executables, specified either through editing the config file for the WTM or by using the “Save Layout” button in the “Use Template” interface mode. The Up/Down, Help, and Close buttons remain in Layout Mode. The other buttons are removed. Additional buttons are added:
Delete Selected Layout—if a layout is selected in the list, this button brings up a confirmation dialog, which if “yes” is selected, causes the selected layout to be deleted.
Use Selected Layout—This button causes the selected layout (if any) to be used. Using a layout will look for running applications that match the applications specified in the layout. Those that are running will be sized and placed according to the layout. If an application isn't run, it is launched and then sized and placed according to the layout.
Templates—This button switches the interface back into the Template Mode, which is the original mode of the interface.

### Tool for Launching Applications and Other Tools Using a Touchscreen

This tool (called the Touch Portal) is a full-screen application with a set of customizable buttons representing applications and other tools. Each button typically includes a graphic or text communicating the application they represent. The buttons should be sized such that they are a bit bigger than a fingertip—nominally 1″×1″ or bigger if the user is likely to be wearing gloves. The buttons can be split into two sections, one for applications, and the other for touchscreen tools. There are two other special buttons, one that dismisses the Portal, and one that sends the Portal window to the background. A configuration file associates buttons with the application or tool they represent, as well as the icon to use for that button. In use, the operator simply brings up the Portal using an interface element (software or hardware) and then either dismisses the Portal, or pushes on the button representing the application or tool they wish to launch. Once the button is pushed, the Portal then goes to the background.

We claim:

1. An interface for a touchscreen-operated computing device, comprising one or more of the following user tools:
Track Screen;
Magnifier;
Virtual Keyboard;
Common Tasks Manager;
Task Switcher;
Camera Snapshot tool; and
Template Manager.

2. The interface of claim 1, wherein the Track Screen tool:
intercepts an input from an absolute pointing device; and
moves a cursor in vector relative to the original input.

3. The interface of claim 2, wherein the absolute pointing device is a touchscreen or digitizer.

4. The interface of claim 2, wherein the Track Screen tool further applies a scaling ratio to the input to amplify or attenuate the magnitude of the input.

5. The interface of claim 2, wherein certain regions of the screen can be excluded from Track Screen processing.

6. The interface of claim 1, wherein the magnifier captures the current screen image, and displays a magnified subset of it.

7. The interface of claim 1, wherein the keyboard is rendered on screen, with sufficient size that the individual keys are easily selectable with an unaided finger.

8. The interface of claim 7, wherein the keyboard is semi-transparent.

9. The interface of claim 1, wherein the Common Tasks Manager allows common keyboard shortcuts, mouse events, and other user interface events to be specified in a configuration file and represented on screen as a large, easy-to-click button.

10. The interface of claim 9, wherein the buttons are automatically arranged in horizontal rows, and presented on screen without a backdrop.

11. The interface of claim 10, wherein each button has a graphic or text representing the action they correspond to.

12. The interface of claim 1, wherein the Task Switcher uses one or more buttons or user inputs to automatically switch between application programs.

13. The interface of claim 1, wherein the Touchscreen Snapshot utility includes a user input to automatically capture an image.

14. The interface of claim 1, wherein the Template Manager is used to specify, and then instantiate, the position and sizes of multiple windows for use with a touchscreen display.
